(19) United States
(12) Patent Application Publication
(10) Pub. No.: US 2006/0290655 A1
(43) Pub. Date: Dec. 28, 2006

(54) Input device including a multi-direction type scroll wheel

(75) Inventor: Chin-Wen Chou, Taipei Hsien (TW)

Correspondence Address: BIRCH STEWART KOLASCH & BIRCH, PO BOX 747, FALLS CHURCH, VA, 22040-0747, US

(73) Assignee: Zippy Technology Corp.

(21) Appl. No.: 11/165,125

(22) Filed: Jun. 24, 2005

(51) Int. Cl. G09G 5/00

(52) U.S. Cl. 345/156

(57) ABSTRACT

An input device with a multi-direction type scroll wheel includes a multi-direction command type switch and a scroll wheel for controlling the switch to output a command. The switch includes a base, a controller, and a pair of positioning bodies. An interior of each positioning bodies is provided with a contacting lead set. An interior of the scroll wheel provided with a guiding portion. When the scroll wheel is rotated forward or backward, moved leftward or rightward, or moved upward or downward, the controller is simultaneously moved by the guiding portion in accordance with the motion of the scroll wheel, thereby electrically connecting the contacting lead sets so as to generate various command signals. The prevent invention achieves the object of outputting various command signals by utilizing multi-direction operation of a single scroll wheel and has the advantages of minimization, simple structure and assembly, and easy operation.

### FIELD OF THE INVENTION

The present invention relates to an input device, and more particularly to an input device including a multi-direction type scroll wheel for scrolling an image in multiple directions.

### BACKGROUND OF THE INVENTION

Recently, according to an electronic product such as a computer mouse, a keyboard, a controller, etc., a user uses right and left functional keys of the electronic products to browse document, search homepage, and enlarge and narrow image. Also, the user can use a scroll wheel except the right and left functional keys, wherein the scroll wheel is disposed between the right and left functional keys. If the user uses the scroll wheel, the use does not need to push page shifting key of “PAGE DOWN” or the user does not need to locate a cursor of the mouse at a vertical scroll bar of the right side of a screen and then push the left key to shift page when the user views the article or image with many pages. The user can directly rotate the scroll wheel upwardly and downwardly to achieve the object of pages shift and lines shift so as to be a convenient operation.

However, recently the widths of many documents often exceed the width of the screen. Specially, according to data table of “EXCEL or ACCESSS” format, the field length of the table is long and thus the user needs to locate the cursor of the mouse at a horizontal scroll bar of the bottom to shift page leftward and rightward when the user wants to view the entire document. This is waste time and often inconvenient to the user of bad eyesight or the use which uses the screen with small size.

In order to solve the above-mentioned problem, U.S. Pat. No. 6,700,564 disclosed an input device including a wheel assembly for scrolling an image in multiple directions. The wheel assemble includes a scroll wheel disposed on a support having a U-shaped opening. The scroll wheel can be rotated and slid relative to the support, whereby the scroll wheel can vertically scrolling the image by utilizing a rotational movement sensing system. In additional, the scroll wheel can be biased leftward or rightward to contact a contact sensor of a sensing system, and thus the image is scrolled leftward or rightward by sensing the leftward or rightward biased movement of the scroll wheel. This achieves the object of vertically and horizontally scrolling image by utilizing a single scroll wheel so as to further increase the convenience of operation.

However, the contact sensor must be electrically connected to a microprocessor, and then the contact sensor can output a signal. This not only increases the assembly cost and complexity but also increase the volume of input device including a multi-direction type scroll wheel. Thus, the electronic product having the input device including a multi-direction type scroll wheel cannot meet the requirement of minimization. In addition, the input device including a multi-direction type scroll wheel has no function of pressing the scroll wheel for inputting a command. Furthermore, the user has no hand felling when the user operates the input device including a multi-direction type scroll wheel. During the rotation of the scroll wheel, it is not easy for the user to control the rotation of the scroll wheel, such that the operating time is long because the scroll wheel must be repeatedly rotated forward or backward when too many images are scrolled.

Accordingly, there exists a need for an input device with a multi-direction type scroll wheel to solve the above-mentioned disadvantages.

### SUMMARY OF THE INVENTION

The present invention provides an input device with a multi-direction type scroll wheel for outputting various command signals by utilizing multi-direction operation of a single scroll wheel.

In order to achieve the foregoing objects, the input device with a multi-direction type scroll wheel including a multi-direction command type switch and a scroll wheel for controlling the switch to output a command. The multi-direction command type switch is assembled and positioned in the hollow engaging area. The multi-direction command type switch includes a base, a controller disposed on the base and a pair of positioning bodies disposed on two sides of the base. An interior of each positioning bodies is provided with a contacting lead set including a plurality of contacting leads. An interior of the hollow engaging area of the scroll wheel provided with a guiding portion, such that the multi-direction command type switch is driven by the guiding portion, and the controller is simultaneously moved in accordance with the motion of the scroll wheel. The controller is provided with a first conductive element simultaneously moved by the controller, and is further provided with two first conductive elements respectively located between the controller and the contacting lead sets for generating various signals when the first and second conductive elements contact the contacting lead sets. When the user rotates the scroll wheel forward or backward, or presses the scroll wheel downward, the second conductive element contact the contacting lead sets disposed on two sides of the base so as to generate different command signals. Furthermore, when the user biases the scroll wheel leftward or rightward, the second conductive element individually contacts the contacting lead set so as to further generate different command signals. The input device with a multi-direction type scroll wheel o the prevent invention achieves the object of vertically and horizontally scrolling image and outputs various command signals by utilizing a single scroll wheel, and has the advantages of minimization, simple structure and assembly, and easy operation.

When the scroll wheel is rotated forward, rotated backward, moved leftward, moved rightward, moved upward or moved downward by the user, the input device can provide the hand feeling by utilizing the guiding portion of the scroll wheel, the protrudent block of the controller, the second conductive element and the second elastic element, whereby the user can precisely output correct command so as to conveniently operate the input device.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective schematic view showing the combination of an input device including a multi-direction type scroll wheel according to a preferable embodiment of the prevent invention.

FIG. 2 is an exploded perspective schematic view of an input device including a multi-direction type scroll wheel according to a preferable embodiment of the prevent invention.

FIGS. 3A and 3B are side elevational schematic views showing the motion of a multi-direction type scroll wheel when a scroll wheel is rotated forward or backward.

FIGS. 4A and 4B are plan schematic views showing the motion of a multi-direction type scroll wheel when a scroll wheel is rotated forward or backward.

FIGS. 5A and 5B are side elevational schematic views showing the motion of a multi-direction type scroll wheel when a scroll wheel is pressed downward.

FIGS. 6A and 6B are side elevational schematic views showing the motion of a multi-direction type scroll wheel when a scroll wheel is biases leftward or rightward.

FIG. 7 is a cross sectional schematic view showing an input device including a multi-direction type scroll wheel applied to a computer mouse according to a preferable embodiment of the prevent invention.

FIG. 8 is a perspective cutaway schematic view showing an input device including a multi-direction type scroll wheel applied to a keyboard according to a preferable embodiment of the prevent invention.

### DETAILED DESCRIPTION OF THE PREFERRED EMBODIMENTS

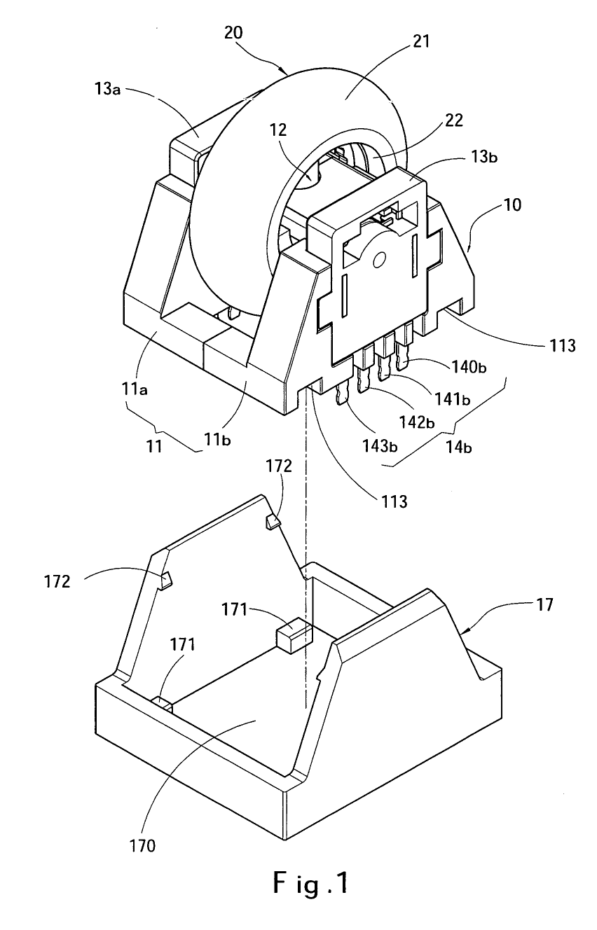

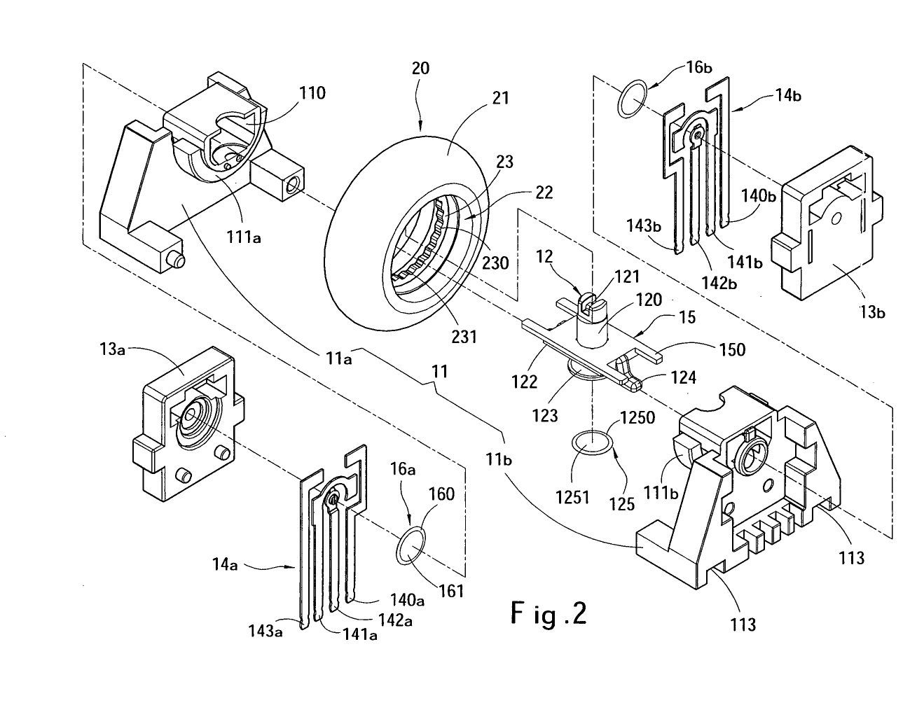

Referring to FIGS. 1 and 2, they depict an input device including a multi-direction type scroll wheel according to a preferable embodiment of the prevent invention. The input device includes a multi-direction command type switch 10 and a scroll wheel 20 assembled to the multi-direction command type switch 10 for controlling and outputting a command.

The multi-direction command type switch 10 includes a base 11, a controller 12 and a pair of positioning bodies 13a, 13b. The base 11 is constituted by two base elements 11a, 11b and defines a receiving portion 110 over the two base elements 11a, 11b. The base 11 further includes two constraining portions 111a, 111b located under and outside the receiving portion 110. The two constraining portions 111a, 111b define a groove 112 which can be a rail for rotating the scroll wheel 20. The controller 12 is disposed in the receiving portion 110 and positioned between the two base elements 11a, 11b. In the preferable embodiment, the controller 12 includes a shaking rod 120 simultaneously moved by the scroll wheel 20, thereby achieving the object of outputting command. The controller 12 includes a protrudent block 121 located over the shaking rod 120 and protruding upward out of the base 11. The shaking rod 120 is disposed over a seat 122, and the shaking rod 120 drives the seat 122 to move. The seat 122 is provided with a first elastic element 123 disposed under the seat 122. In the preferable embodiment, the first elastic element 123 is shape of bell. The first elastic element 123 is made of rubber or silica gel but not to restrain the present invention. Thus, the controller 12 can be positioned in the receiving portion 110, and the seat 122 can be moved upward or downward by utilizing the elasticity of the first elastic element 123 when the scroll wheel is up or down. In addition, two sides of the seat 122 are provided with two protrudent ears 124.

The positioning bodies 13a, 13b are respectively disposed on two sides of the two base elements 11a, 11b. An interior of each positioning bodies 13a, 13b is provided with a contacting lead set 14a, 14b. Each contacting lead set 14a, 14b is integrally formed with the positioning body 13a, 13b by using an embedded ejection molding process. In the preferable embodiment, each contacting lead set 14a, 14b includes a first contacting lead 140a, 140b, a second contacting lead 141a, 141b, a third contacting lead 142a, 142b and a fourth contacting lead 143a, 143b. In the preferable embodiment, the second contacting lead 141a, 141b and the third contacting lead 142a, 142b are disposed between the first contacting lead 140a, 140b and the fourth contacting lead 143a, 143b.

In the preferable embodiment, a first conductive element 15 and two second conductive elements 16a, 16b are electrically connected to the contacting lead sets 14a, 14b for forming a circuit. The first conductive element 15 is mounted over the seat 122 of the controller 12, whereby the first conductive element 15 can be moved when the controller 12 moves. The first conductive element 15 includes four contacting ends 150 expanding outward. In normal situation, the four contacting ends 150 do not contact the contacting lead sets 14a, 14b. During operation, the scroll wheel 20 drives the controller 12 to move forward, backward or downward, whereby the four contacting ends 150 contact the contacting lead sets 14a, 14b for outputting various commands. Each second conductive element 16a, 16b is disposed between the protrudent ear 124 of the controller 12 and the contacting lead set 14a, 14b, and is positioned over the second contacting lead 141a, 141b, whereby the second conductive element 16a, 16b can be moved leftward or rightward relative to the protrudent ear 124 for resulting in the hand feeling of pressing. In the preferable embodiment, each second conductive element 16a, 16b is a circular reed, and includes a protrudent portion 161 and a flat portion 160 around the protrudent portion 161. In normal situation, the flat portion 160 contacts the second contacting lead 141a, 141b, and the protrudent portion 161 contacts the protrudent ear 124. When the scroll wheel 20 drives the controller 12 to move leftward or rightward, the protrudent ear 124 presses the protrudent portion 161 of the second conductive element 16a, 16b for electrically connecting the second contacting lead 141a, 141b to the third contacting lead 142a, 142b so as to generate a command signal. The detail will be described hereinafter. The second conductive element 16a, 16b can be any conductive or switch which can electrically connect the second contacting lead 141a, 141b to the third contacting lead 142a, 142b by utilizing the pressing of the protrudent ear 124, and a circular reed is used to restrain the present invention.

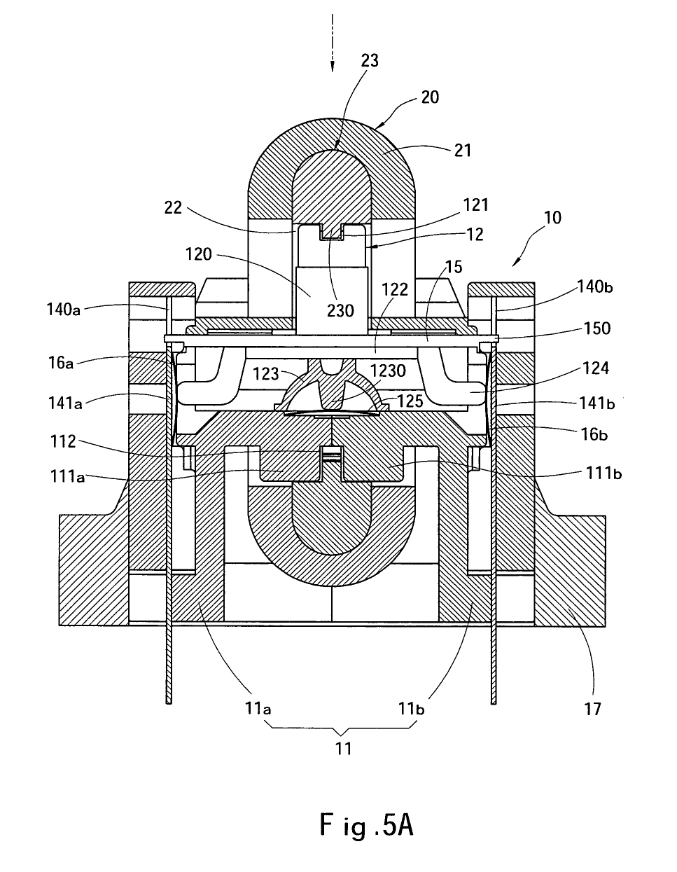

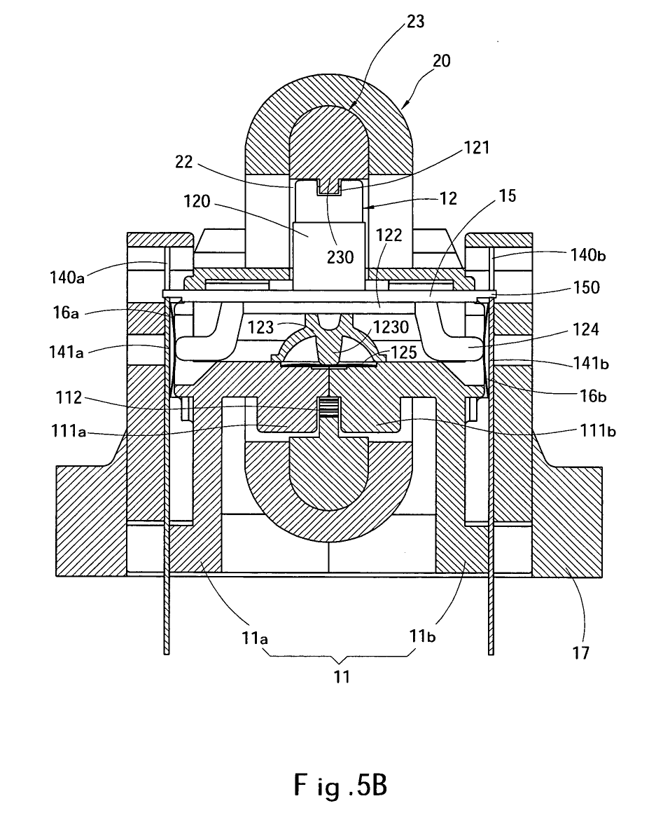

Referring to FIG. 5A, it depicts that the scroll wheel 20 controls the multi-direction command type switch 10 for outputting a command according to a preferable embodiment of the prevent invention. The scroll wheel 20 includes an outer area 21 for receiving a force and then rotating the scroll wheel 20 and a hollow engaging area 22 of a guiding portion 23 simultaneously moved by the outer area 21. The multi-direction command type switch 10 is constrained and disposed in the hollow engaging area 22. In the preferable embodiment, the multi-direction command type switch 10 is driven by the guiding portion 23 for outputting multi-direction command signals in accordance with different motion of the scroll wheel 20. The guiding portion 23 provided with a plurality of guiding blocks 230 and guiding grooves 231 separated by each other and connected to each other in sequence. The two constraining portions 111a, 111b define a groove 112 which can be a rail for rotating the scroll wheel 20. In normal situation, the scroll wheel 20 is snapped into the protrudent block 121 of the shaking rod 120, and then the protrudent block 121 is positioned in the guiding grooves 231 of the guiding portion 23, whereby the scroll wheel 20 can drive the controller 12 to move leftward, rightward or downward. In addition, when the user rotates the scroll wheel 20, the guiding blocks 230 of the guiding portion 23 pushes the protrudent block 121 and thus the controller 12 is driven to move forward or backward, thereby electrically connecting to the contacting lead sets 14a, 14b.

In addition, in the preferable embodiment, the hand feeling of pressing is designed. The first elastic element 123 of the controller 12 includes a pressing rod 1230 protruding downward and a second elastic element 125 disposed between the receiving portion 110 and the first elastic element 123. In the preferable embodiment, the second elastic element 125 is a circular reed, and includes a protrudent portion 1251 and a flat portion 1250 around the protrudent portion 1251. In normal situation, the flat portion 1251 contacts the pressing rod 1230. When the scroll wheel 20 is pressed, the scroll wheel 20 drives the controller 12 to move downward. Thus, the first elastic element 123 is pressed and then the pressing rod 1230 presses the protrudent portion 1251, thereby resulting in the hand feeling. The second elastic element 125 can be any element which is elastic and can result in the hand feeling when the element is pressed, and the circular reed is not used to restrain the second elastic element 125 of the present invention.

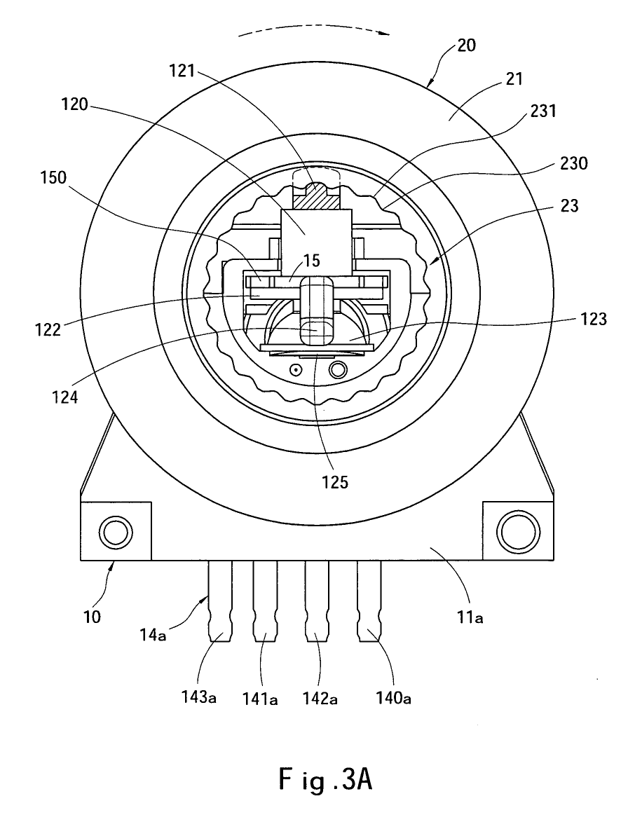

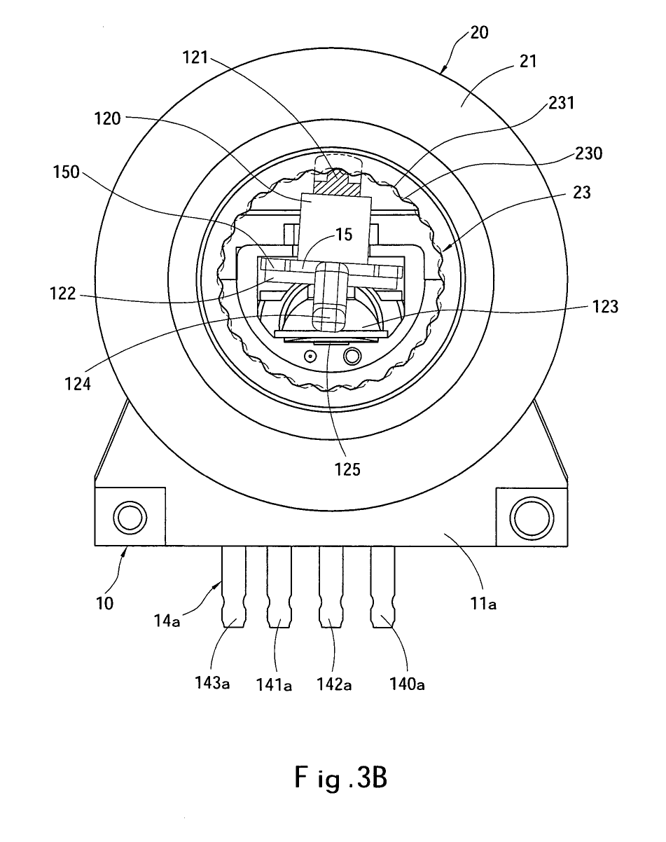

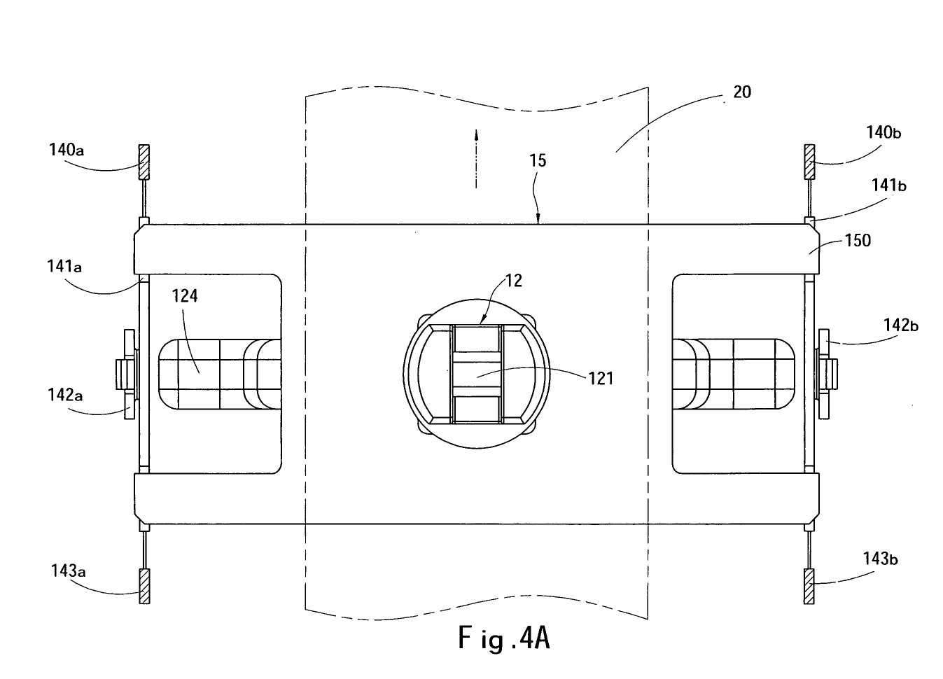

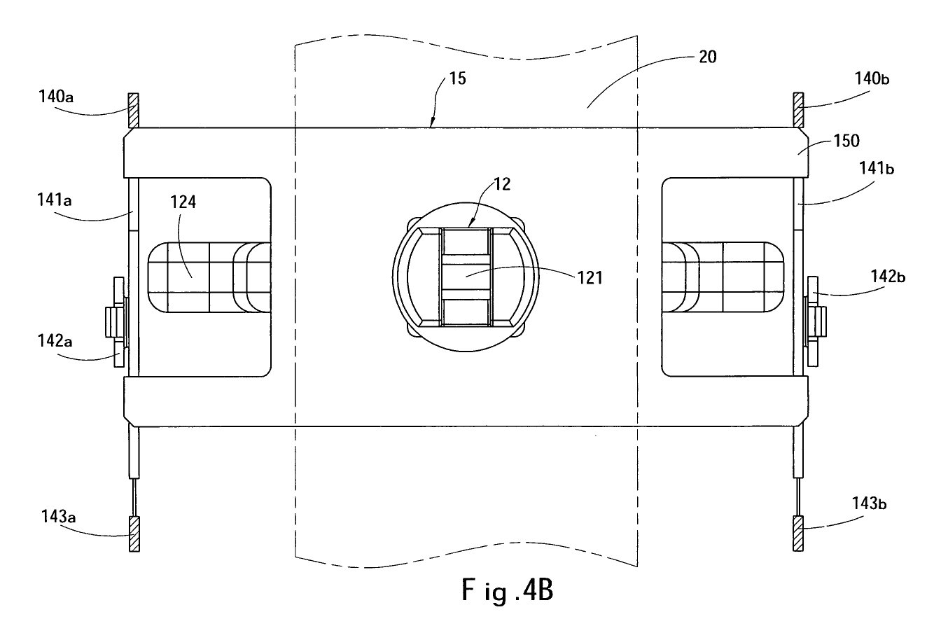

After the multi-direction command type switch 10 and the scroll wheel 20 are assembled, the input device further includes a mounting base 17 disposed outside the positioning bodies 13a, 13b and the base elements 11a, 11b. The mounting base 17 includes a hollow portion 170, wherein the contacting lead sets 14a, 14b pass through the hollow portion 170. The whole input device including a multi-direction type scroll wheel is assembled and mounted by respectively snapping a plurality of first snapping blocks 171 and second snapping blocks 172 into a snapping portion 113 and top edge of the base 11. Referring to FIGS. 3A, 3B, 4A, and 4B, they depict that an input device including a multi-direction type scroll wheel is used in the preferable embodiment. In normal situation, the shaking rod 120 of the controller 12 is positioned in the guiding grooves 231 of the guiding portion 23, such that the scroll wheel 20 is snapped into the controller 12 (shown in FIG. 3A). Also, the four contacting ends 150 of the first conductive element 15 do not contact the contacting lead sets 14a, 14b (shown in FIG. 4A). When the user rotates the scroll wheel 20 forward, the guiding block 230 pushes the protrudent block 121 (shown in FIG. 3B), such that the controller 12 drives the first conductive element 15 to move forward, and then the contacting ends 150 of the first conductive element 15 contact the first contacting lead 140a, 140b of the contacting lead sets 14a, 14b (shown in FIG. 4A) so as to generate a command for scrolling the image upward. Likewise, when the user rotates the scroll wheel 20 backward, the controller 12 drives the first conductive element 15 to move backward, and then the contacting ends 150 of the first conductive element 15 contact the fourth contacting lead 143a, 143b of the contacting lead sets 14a, 14b so as to generate a command for scrolling the image downward. In the preferable embodiment, the relative motion of the protrudent block 121, the guiding blocks 230 of the guiding portion 23 and the guiding groove 231 can result in the hand feeling and constrain the rotation of the scroll wheel 20. Thus, the scroll wheel cannot be repeatedly rotated forward or backward when too many images are scrolled.

Referring to FIGS. 5A and 5B, in normal situation the four contacting ends 150 of the first conductive element 15 do not contact the contacting lead sets 14a, 14b (shown in FIG. 5A). When the user presses the scroll wheel 20 downward, the scroll wheel 20 drives the controller 12 and the first conductive element 15 to move downward and the first elastic element 123 is pressed and then deformed, thereby upward generating a recoverable elastic force. Then, the contacting ends 150 of the first conductive element 15 contact the second contacting lead 141a, 141b of the contacting lead sets 14a, 14b so as to generate a pressing command (shown in FIG. 5B). When the user stops pressing the scroll wheel 20, the recoverable elastic force of the first elastic element 123 can be released and the controller goes back to the original condition, such that the first conductive element 15 does not contact the contacting lead sets 14a, 14b. In the preferable embodiment, when the scroll wheel 20 is pressed, the first elastic element 123 is pressed and then the pressing rod 1230 of the first elastic element 123 presses the second elastic element 125, thereby resulting in the hand feeling.

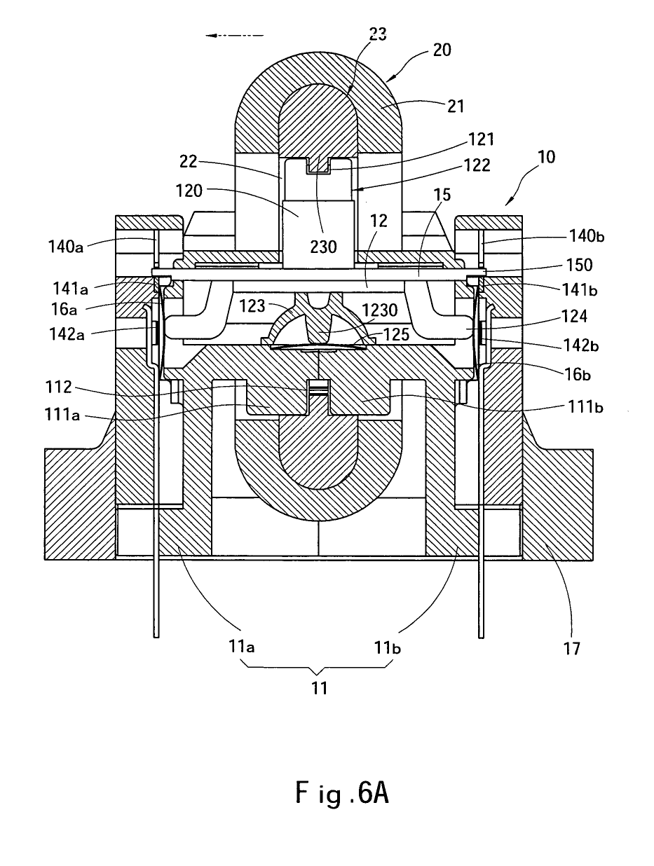

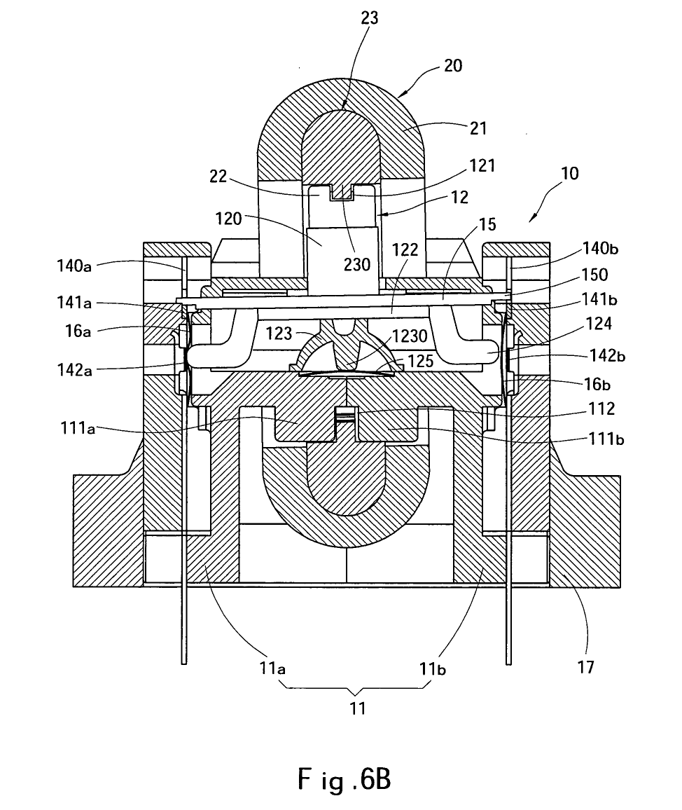

In addition, in the preferable embodiment, the input device including a multi-direction type scroll wheel can scroll the image leftward or rightward. Referring to FIGS. 6A and 6B, in normal situation the second conductive elements 16a, 16b are positioned at the second contacting lead 141a, 141b and contact the second contacting lead 141a, 141b (shown in FIG. 6A). When the user biases the scroll wheel 20 leftward, the scroll wheel 20 is snapped into the controller 12 and the controller 12 is driven to move leftward. Then, the protrudent ear 124 presses the pretrudent portion 161 of the second conductive element 16a, such that the pretrudent portion 161 is concaved and contacts the third contacting lead 142a, thereby electrically connecting the second contacting lead 141a to the third contacting lead 142a so as to generate a command for scrolling the image leftward, and the second conductive element 16a can result in the hand feeling of pressing (shown in FIG. 6B). Likewise, when the user biases the scroll wheel 20 rightward, the controller 12 is driven to move rightward, and the protrudent ear 124 presses the pretrudent portion 161 of the second conductive element 16b, such that the pretrudent portion 161 is concaved and contacts the third contacting lead 142b, thereby electrically connecting the second contacting lead 141b to the third contacting lead 142b so as to generate a command for scrolling the image rightward.

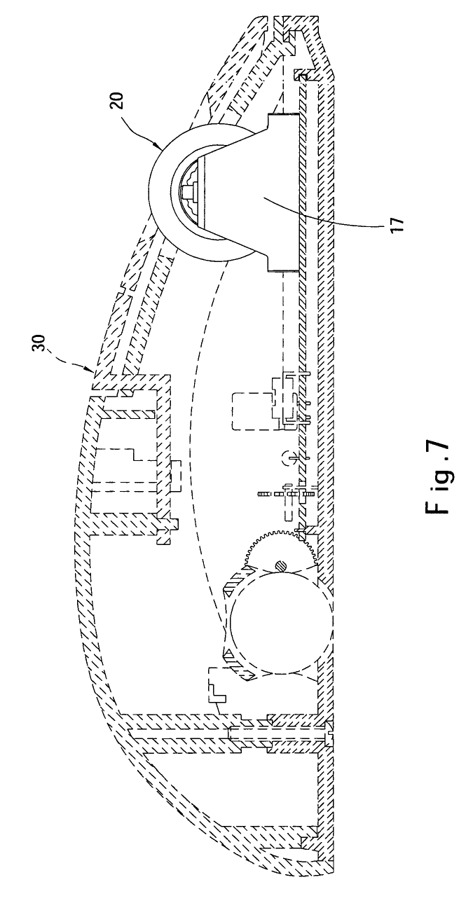

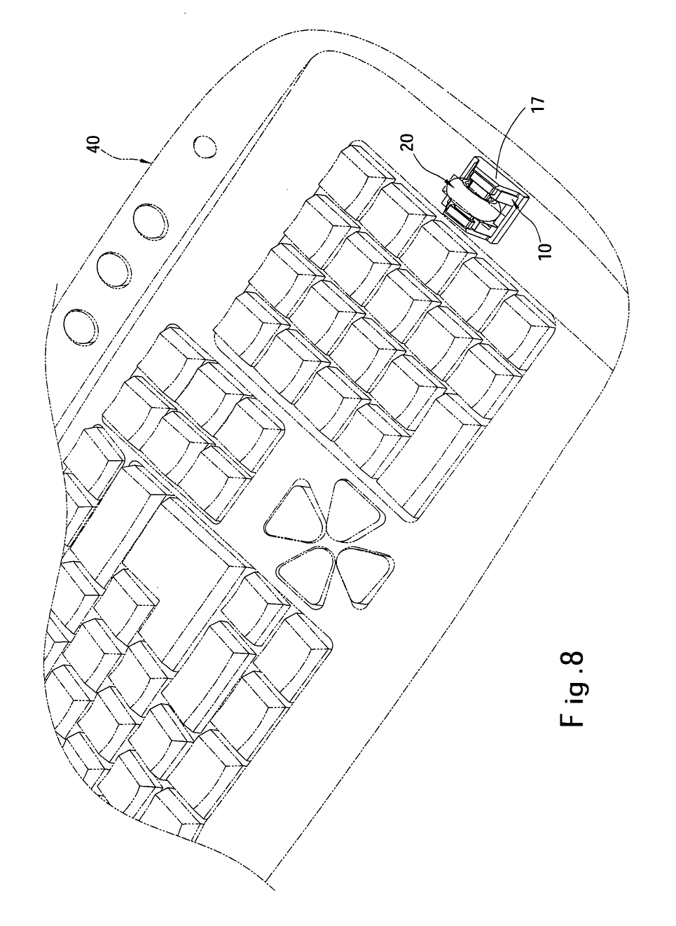

In the preferable embodiment, the input device including a multi-direction type scroll wheel is applied to an electronic product such as a computer mouse 30 (shown in FIG. 7), a keyboard 40 (shown in FIG. 8), a controller (not shown), etc. for outputting various command signals. Furthermore, the shape of dish shown in figure is used to restrain the scroll wheel 20 of the present invention, and the shape of the scroll wheel 20 can be cylindrical or other shape in accordance with the corresponding electronic product.

In conclusion, the input device including a multi-direction type scroll wheel of the prevent invention utilizes the scroll wheel 20 assembled to the multi-direction command type switch 10, whereby the scroll wheel 20 controls the multi-direction command type switch 10 to output a command. When the scroll wheel 20 is rotated forward, rotated backward, moved leftward, moved rightward, moved upward or moved downward, the input device can output various commands and provide the hand feeling. Thus, the input device including a multi-direction type scroll wheel of the prevent invention has the advantages of minimization, simple structure and assembly, and easy operation. Also, the input device including a multi-direction type scroll wheel of the prevent invention achieves the object of vertically and horizontally scrolling image by utilizing a single scroll wheel 20.

Although the invention has been explained in relation to its preferred embodiment, it is not used to restrain the invention. It is to be understood that many other possible modifications and variations can be made by those skilled in the art without departing from the spirit and scope of the invention as hereinafter claimed.

What is claimed is:

1. An input device including a multi-direction type scroll wheel comprising:
a scroll wheel including an outer area for receiving a force and then rotating the scroll wheel and a hollow engaging area of a guiding portion simultaneously moved by the outer area; and
a multi-direction command type switch constrained and disposed in the hollow engaging area, and driven by the guiding portion for outputting multi-direction command signals in accordance with different motion of the scroll wheel.

2. The input device including a multi-direction type scroll wheel according to claim 1, wherein the motion of the scroll wheel is selected from one of a group of forward rotation, backward rotation, leftward movement, rightward movement, upward movement and downward movement and the combination of the group.

3. The input device including a multi-direction type scroll wheel according to claim 1, wherein the guiding portion includes a plurality of guiding blocks and guiding grooves separated by each other and connected to each other in sequence, and the multi-direction command type switch includes a base provided with a controller simultaneously moved by the guiding portion in accordance with the motion of the scroll wheel.

4. An input device including a multi-direction type scroll wheel comprising:
a scroll wheel including an outer area for receiving a force and then rotating the scroll wheel and a hollow engaging area of a guiding portion simultaneously moved by the outer area; and
a multi-direction command type switch constrained and disposed in the hollow engaging area, and including a base, a controller disposed on the base and a pair of positioning bodies disposed on two sides of the base 1, wherein the controller is simultaneously moved by the guiding portion in accordance with the motion of the scroll wheel, an interior of each positioning bodies is provided with a contacting lead set, the controller is provided with a first conductive element which does not contact the contacting lead sets in normal situation, and the scroll wheel is rotated forward or backward to drive the first conductive element of the controller, whereby the first conductive element contacts the contacting lead sets for outputting various rotating commands.

5. The input device including a multi-direction type scroll wheel according to claim 4, wherein the controller includes a seat and a shaking rod disposed on the seat, and the seat is provided with a first elastic element disposed under the seat for positioning on the base, the controller includes a protrudent block located over the shaking rod, and the guiding portion includes a plurality of guiding blocks and guiding grooves separated by each other and connected to each other in sequence, whereby the protrudent block is snapped into the guiding portion and is simultaneously moved by the guiding portion.

6. The input device including a multi-direction type scroll wheel according to claim 4, wherein the base defines a receiving portion over the base and the controller is disposed in the receiving portion and protruding upward out of the base.

7. The input device including a multi-direction type scroll wheel according to claim 4, wherein the base includes two constraining portions defining a groove which is a rail for rotating the scroll wheel.

8. The input device including a multi-direction type scroll wheel according to claim 4, wherein the first conductive element includes four contacting ends expanding outward, and the contacting ends do not contact the contacting lead sets in normal situation.

9. The input device including a multi-direction type scroll wheel according to claim 4, wherein each contacting lead set includes a first contacting lead and a fourth contacting lead.

10. The input device including a multi-direction type scroll wheel according to claim 9, wherein the first conductive element does not contact the first contacting lead and the fourth contacting lead in normal situation, and the scroll wheel drives the first conductive element to move forward or backward and then contact the first contacting lead or the fourth contacting lead when the scroll wheel is rotated forward or backward.

11. The input device including a multi-direction type scroll wheel according to claim 4, further comprising a mounting base disposed outside the base and the positioning bodies for assembling and mounting the input device including a multi-direction type scroll wheel.

12. An input device including a multi-direction type scroll wheel comprising:
a scroll wheel including an outer area for receiving a force and then rotating the scroll wheel and a hollow engaging area of a guiding portion simultaneously moved by the outer area; and
a multi-direction command type switch constrained and disposed in the hollow engaging area, and including a base, a controller disposed on the base and a pair of positioning bodies disposed on two sides of the base, wherein the controller is simultaneously moved by the guiding portion in accordance with the motion of the scroll wheel, an interior of each positioning bodies is provided with a contacting lead set, the controller is provided with a first conductive element which does not contact the contacting lead sets in normal situation, the scroll wheel is rotated forward or backward to drive the first conductive element of the controller such that the first conductive element contacts the contacting lead sets for outputting various rotating commands, the controller is provided with two second conductive elements respectively located between the controller and the contacting lead sets, and the scroll wheel is biased leftward or rightward to drive the controller to press the second conductive element such that the second conductive element individually leftward or rightward contacts the contacting lead set for outputting various leftward or rightward moving commands.

13. The input device including a multi-direction type scroll wheel according to claim 12, wherein the controller includes a seat and a shaking rod disposed on the seat, and the seat is provided with a first elastic element disposed under the seat for positioning on the base, the controller includes a protrudent block located over the shaking rod, and the guiding portion includes a plurality of guiding blocks and guiding grooves separated by each other and connected to each other in sequence, whereby the protrudent block is snapped into the guiding portion and is simultaneously moved by the guiding portion.

14. The input device including a multi-direction type scroll wheel according to claim 13, wherein two sides of the seat are provided with two protrudent ears and the protrudent ear presses the second conductive element when the scroll wheel is biased leftward and rightward.

15. The input device including a multi-direction type scroll wheel according to claim 12, wherein the base defines a receiving portion over the base and the controller is disposed in the receiving portion and protruding upward out of the base.

16. The input device including a multi-direction type scroll wheel according to claim 12, wherein the base includes two constraining portions defining a groove which is a rail for rotating the scroll wheel.

17. The input device including a multi-direction type scroll wheel according to claim 12, wherein the first conductive element includes four contacting ends expanding outward, and the contacting ends do not contact the contacting lead sets in normal situation.

18. The input device including a multi-direction type scroll wheel according to claim 12, wherein each contacting lead set includes a first contacting lead and a fourth contacting lead.

19. The input device including a multi-direction type scroll wheel according to claim 18, wherein the first conductive element does not contact the first contacting lead and the fourth contacting lead in normal situation, and the scroll wheel drives the first conductive element to move forward and backward and then contact one of the first contacting lead and the fourth contacting lead when the scroll wheel is rotated forward and backward.

20. The input device including a multi-direction type scroll wheel according to claim 18, wherein each contacting lead set further includes a second contacting lead and a third contacting lead located between the first contacting lead and the fourth contacting lead.

21. The input device including a multi-direction type scroll wheel according to claim 20, wherein the second conductive element contacts the second contacting lead in normal situation and the second contacting lead electrically connects the second contacting lead to the third contacting lead when the scroll wheel is biased leftward and rightward.

22. The input device including a multi-direction type scroll wheel according to claim 21, wherein each second conductive element is a circular reed and includes a protrudent portion and a flat portion around the protrudent portion, in normal situation the flat portion contacts the second contacting lead, and the protrudent portion contacts the protrudent ear.

23. The input device including a multi-direction type scroll wheel according to claim 12, further comprising a mounting base disposed outside the base and the positioning bodies for assembling and mounting the input device including a multi-direction type scroll wheel.

24. The input device including a multi-direction type scroll wheel according to claim 12, wherein the scroll wheel is pressed downward to drive the first conductive element to move downward and then contact the contacting lead sets so as to generate a pressing signal.

25. The input device including a multi-direction type scroll wheel according to claim 24, wherein the controller includes a seat and a shaking rod disposed on the seat, and the seat is provided with a first elastic element disposed under the seat for positioning on the base, the controller includes a protrudent block located over the shaking rod, and the guiding portion includes a plurality of guiding blocks and guiding grooves separated by each other and connected to each other in sequence, whereby the protrudent block is snapped into the guiding portion and is simultaneously moved by the guiding portion.

26. The input device including a multi-direction type scroll wheel according to claim 25, wherein the first elastic element includes a pressing rod protruding downward and a second elastic element disposed under the first elastic element, and pressing rod presses the second elastic element so as to result in the hand feeling when the scroll wheel is pressed downward.

27. The input device including a multi-direction type scroll wheel according to claim 26, wherein the second elastic element is a circular reed.

28. The input device including a multi-direction type scroll wheel according to claim 24, wherein the base defines a receiving portion over the base and the controller is disposed in the receiving portion and protruding upward out of the base.

29. The input device including a multi-direction type scroll wheel according to claim 24, wherein the base includes two constraining portions defining a groove which is a rail for rotating the scroll wheel.

30. The input device including a multi-direction type scroll wheel according to claim 24, wherein the first conductive element includes four contacting ends expanding outward, and the contacting ends do not contact the contacting lead sets in normal situation.

31. The input device including a multi-direction type scroll wheel according to claim 24, wherein each contacting lead set includes a second contacting lead.

32. The input device including a multi-direction type scroll wheel according to claim 31, wherein the first conductive element does not contact the second contacting lead in normal situation, and the scroll wheel is pressed downward to drive the first conductive element to move downward and then contact the second contacting leads.

33. The input device including a multi-direction type scroll wheel according to claim 24, further comprising a mounting base disposed outside the base and the positioning bodies for assembling and mounting the input device including a multi-direction type scroll wheel.

34. The input device including a multi-direction type scroll wheel according to claim 12, wherein the scroll wheel is pressed downward to drive the first conductive element to move downward and then contact the contacting lead sets so as to generate a pressing signal.

35. The input device including a multi-direction type scroll wheel according to claim 34, wherein the controller includes a seat and a shaking rod disposed on the seat, and the seat is provided with a first elastic element disposed under the seat for positioning on the base, the controller includes a protrudent block located over the shaking rod, and the guiding portion includes a plurality of guiding blocks and guiding grooves separated by each other and connected to each other in sequence, whereby the protrudent block is snapped into the guiding portion and is simultaneously moved by the guiding portion.

36. The input device including a multi-direction type scroll wheel according to claim 35, wherein the first elastic element includes a pressing rod protruding downward and a second elastic element disposed under the first elastic element, and the pressing rod presses the second elastic element so as to result in the hand feeling when the scroll wheel is pressed downward.

37. The input device including a multi-direction type scroll wheel according to claim 36, wherein the second elastic element is a circular reed.

38. The input device including a multi-direction type scroll wheel according to claim 34, wherein the base defines a receiving portion over the base and the controller is disposed in the receiving portion and protruding upward out of the base.

39. The input device including a multi-direction type scroll wheel according to claim 34, wherein the base includes two constraining portions defining a groove which is a rail for rotating the scroll wheel.

40. The input device including a multi-direction type scroll wheel according to claim 34, wherein the first conductive element includes four contacting ends expanding outward, and the contacting ends do not contact the contacting lead sets in normal situation.

41. The input device including a multi-direction type scroll wheel according to claim 34, wherein each contacting lead set includes a second contacting lead.

42. The input device including a multi-direction type scroll wheel according to claim 41, wherein the first conductive element does not contact the second contacting lead in normal situation, and the scroll wheel is pressed downward to drive the first conductive element to move downward and then contact the second contacting leads.

43. The input device including a multi-direction type scroll wheel according to claim 34, wherein further comprising a mounting base disposed outside the base and the positioning bodies for assembling and mounting the input device including a multi-direction type scroll wheel.
